(19) United States
(12) Patent Application Publication
(10) Pub. No.: US 2025/0264106 A1
(43) Pub. Date: Aug. 21, 2025

(54) ELECTRIC COMPRESSOR

(71) Applicant: KABUSHIKI KAISHA TOYOTA JIDOSHOKKI, Kariya-shi (JP)

(72) Inventors: Hiroaki Ito, Kariya-shi (JP); Junya Yano, Kariya-shi (JP); Yusuke Kinoshita, Kariya-shi (JP); Harutaka Watanabe, Kariya-shi (JP)

(73) Assignee: KABUSHIKI KAISHA TOYOTA JIDOSHOKKI, Kariya-shi (JP)

(21) Appl. No.: 19/013,481

(22) Filed: Jan. 8, 2025

(30) Foreign Application Priority Data
Feb. 15, 2024 (JP) 2024-021152

(51) Int. Cl. F04D 25/06

(52) U.S. Cl. CPC F04D 25/0693; H01R 2201/00

(57) ABSTRACT

An electric compressor includes a rotary shaft, a compression part, a motor, an inverter that has an inverter circuit, and a housing. The housing includes a motor housing having a peripheral wall extending in an axial direction of the rotary shaft and a bottom wall, an inverter housing that is provided on the peripheral wall, a compression part housing, a shaft support member that has an insertion hole. The inverter housing has an extending portion extending in the axial direction away from the peripheral wall and having a high voltage connector and a low voltage connector. The high voltage connector and the low voltage connector are overlapped with the bottom wall as viewed in the axial direction and disposed within a width of the extending portion.

### CROSS-REFERENCE TO RELATED APPLICATION

This application claims priority to Japanese Patent Application No. 2024-021152 filed on Feb. 15, 2024, the entire disclosure of which is incorporated herein by reference.

### BACKGROUND ART

The present disclosure relates to an electric compressor.

An example of a conventional electric compressor is disclosed in Japanese Patent Application Publication No. 2003-324903. This electric compressor includes a compression part, a motor, an inverter, and a housing.

The compression part is driven by rotation of a rotary shaft to compress fluid. The motor rotates the rotary shaft. The inverter has an inverter circuit that drives the motor. The housing includes a motor housing and an inverter housing. The motor housing accommodates the motor. The inverter housing accommodates the inverter.

In this electric compressor, the inverter housing is disposed on an outer peripheral surface side of the motor housing, and the motor housing and the inverter housing are arranged in a radial direction of the rotary shaft. With this arrangement, it is suppressed that an axial length of the electric compressor increases.

Furthermore, in this electric compressor, each of a high voltage connector and a low voltage connector is connected to a side surface of the inverter housing. A power is supplied from an external power supply to the motor through the high voltage connector. The low voltage connector is a communication connector through which control signals from an external controller, which have a power smaller than the power supplied from the external power supply, are sent to the inverter.

For example, in a case where a compressor module formed by integrating an electric compressor and a plurality of devices forming a heat pump cycle is used in an air conditioner mounted on a vehicle or the like, it is required to decrease a size of the electric compressor in order to improve ease of mounting this air conditioner on the vehicle.

However, in the above-described conventional electric compressor, the high voltage connector and the low voltage connector are provided so as to protrude from a side surface of an outer frame portion that is a part of the inverter housing. More specifically, when a direction orthogonal to an axial direction of the rotary shaft is defined as a width direction of the inverter housing, these connectors protrude laterally from the side surface of the inverter housing that is oriented in the width direction. Thus, the inverter housing increases its size in the width direction orthogonal to the axial direction of the rotary shaft by a length of a protruding portion from the side surface of the inverter housing in each of these connectors.

In addition, when the high voltage connector and the low voltage connector protrude from the side surface of the inverter housing, the protruding portions are easily damaged by an external impact.

The present disclosure is made in view of the above-described conventional circumstances, and is directed to, in an electric compressor where an inverter housing is provided on a peripheral wall of a cylindrical motor housing, suppressing an increase of size of the inverter housing in an axial direction of a rotary shaft and suppressing that a high voltage connector and a low voltage connector are damaged.

### SUMMARY

In accordance with an aspect of the present disclosure, there is provided an electric compressor including a rotary shaft, a compression part that is driven by rotation of the rotary shaft to compress fluid, a motor that rotates the rotary shaft, an inverter that has an inverter circuit configured to drive the motor, and a housing in which the rotary shaft, the compression part, the motor, and the inverter are accommodated. The housing includes a motor housing that is formed in a bottomed tubular shape having a tubular peripheral wall extending in an axial direction of the rotary shaft and a bottom wall connected to an end of the peripheral wall and in which the motor is accommodated inside the peripheral wall, an inverter housing that is provided on the peripheral wall and in which the inverter is accommodated, a compression part housing that is formed in a bottomed tubular shape and provided opposite to the bottom wall across the motor and in which the compression part is accommodated, and a shaft support member that has an insertion hole through which the rotary shaft is inserted, the shaft support member being disposed between an opening of the motor housing and an opening of the compression part housing, the shaft support member rotatably supporting the rotary shaft, the shaft support member defining with the motor housing a motor chamber in which the motor is accommodated and defining with the compression part housing a compression part chamber in which the compression part is accommodated. The inverter housing has an extending portion extending in the axial direction relative to the bottom wall away from the peripheral wall. The extending portion has a high voltage connector through which a power from a high voltage power supply is supplied to the motor and a low voltage connector through which a power smaller than the power supplied from the high voltage power supply is supplied to the inverter. The high voltage connector and the low voltage connector are each overlapped with the bottom wall as viewed in the axial direction of the rotary shaft. The high voltage connector and the low voltage connector are disposed within a width of the extending portion.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a left side view schematically illustrating a compressor module including an electric compressor of a first embodiment;

FIG. 2 is a top view schematically illustrating the compressor module including the electric compressor of the first embodiment;

FIG. 3 is a back view schematically illustrating the compressor module including the electric compressor of the first embodiment;

FIG. 4 is a partial top view schematically and mainly illustrating an inverter housing according to the electric compressor of the first embodiment;

FIG. 5 is a back view schematically illustrating the inverter housing, a motor housing, a power supply connector as a high voltage connector, a communication connector as a low voltage connector, an electric connecting member, and mounting legs according to the electric compressor of the first embodiment;

FIG. 6 is a partial perspective view schematically illustrating a part of the inverter housing, a part of the motor housing, and a hermetically sealed terminal according to the electric compressor of the first embodiment;

FIG. 7 is a perspective view schematically illustrating a part of a case and busbars in the electric connecting member, a part of the hermetically sealed terminal, and a part of the inverter housing according to the electric compressor of the first embodiment;

FIG. 8 is a perspective view schematically illustrating the inverter housing, the power supply connector, and the communication connector according to the electric compressor of the first embodiment;

FIG. 9 is a perspective view schematically illustrating the electric connecting member, as viewed from diagonally behind the electric connecting member, according to the electric compressor of the first embodiment;

FIG. 10 is a perspective view schematically illustrating the electric connecting member, as viewed from diagonally in front of the electric connecting member, according to the electric compressor of the first embodiment;

FIG. 11 is a perspective view schematically illustrating a part of the case, the busbars, receptacle terminals as first terminals provided on one end portions of the busbars, and plugs as second terminals provided on the other end portions of the busbars, as viewed from diagonally behind them, according to the electric compressor of the first embodiment;

FIG. 12 is a perspective view schematically illustrating a state where the receptacle terminals provided on the one end portions of the busbars are connected to conductive pins in the hermetically sealed terminal and the plugs provided on the other end portions of the busbars are connected to jacks as inverter terminals, according to the electric compressor of the first embodiment; and

FIG. 13 is a back view schematically illustrating an inverter housing, a motor housing, a power supply connector, a communication connector, an electric connecting member, and mounting legs, according to an electric compressor of a second embodiment.

### DETAILED DESCRIPTION OF THE EMBODIMENTS

The following will describe a first embodiment and a second embodiment according to the present disclosure with reference to the drawings.

### First Embodiment

An electric compressor (hereinafter, simply called the compressor) 20 of the first embodiment is specifically a scroll electric compressor. This compressor 20 is mounted on a vehicle, which is not illustrated, and is used in an air conditioner for the vehicle. This air conditioner for the vehicle is a heat pump cycle device that performs air-conditioning inside a vehicle interior and controls temperature of equipment mounted on the vehicle.

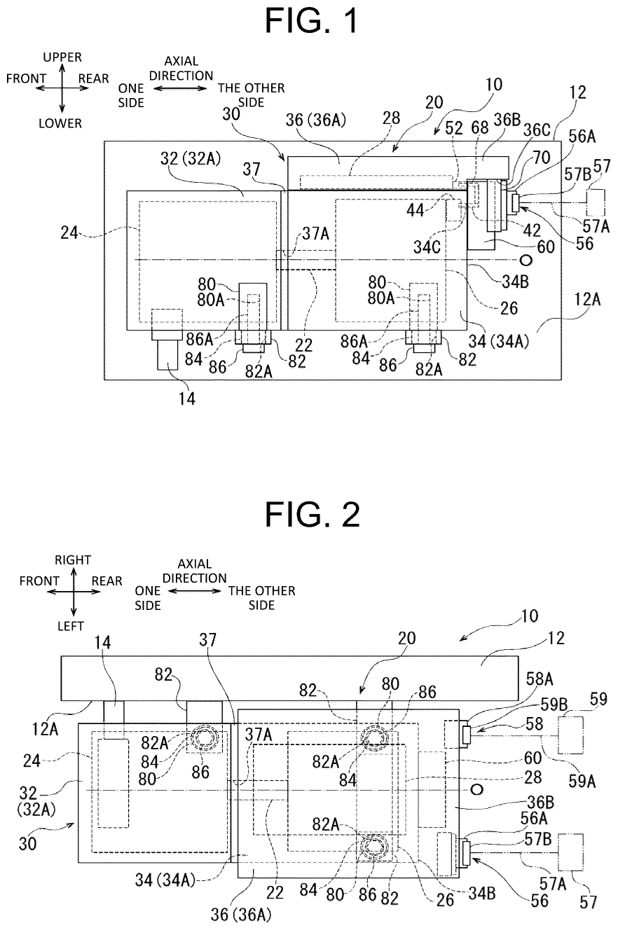

In the present embodiment, a front-rear direction and an up-down direction of the compressor 20 are defined by solid arrows illustrated in FIG. 1. In addition, in FIG. 1, a front side of a sheet is defined as a left side of the compressor 20 and a rear side of the sheet is defined as a right side of the compressor 20. In FIG. 2 and subsequent figures, the front-rear direction, the up-down direction, and the left-right direction of the compressor 20 are defined in correspondence with FIG. 1. In the following description, a front and rear, an upper and lower, and a left and right are all determined based on the front and rear, the upper and lower, and the left and right in FIG. 1. Note that these directions are examples used for ease of explanation, and a posture of the compressor 20 is changed as appropriate in correspondence with a vehicle on which the compressor 20 is mounted, or the like.

As illustrated in FIGS. 1 to 3, the compressor 20 of the first embodiment is a part of a compressor module 10 assembled in a heat pump cycle device, which is not illustrated. The compressor module 10 is formed of a plurality of devices that is integrated with each other and constitutes the heat pump cycle device. Specifically, the compressor module 10 is formed by integrating, for example, an expansion valve, a regulating valve, an on-off valve, a chiller, a receiver, and a water heat exchanger, and a muffler in addition to the compressor 20, of the devices that constitutes the heat pump cycle devices. Illustrations of these devices excluding the compressor 20 are omitted.

This heat pump cycle device switches and controls the on-off valve or the like in accordance with various operation modes to heat or cool an air flown into the vehicle interior by refrigerant circulating in a refrigerant circuit and to cool a cooling heat medium circulating in a heat medium circuit by the refrigerant circulating in the refrigerant circuit.

This compressor module 10 includes a flow passage box 12 formed in a substantially rectangular flat shape. The plurality of devices that constitutes the heat pump cycle device is attached to the flow passage box 12. Although not illustrated, the flow passage box 12 includes a heat medium passage through which the cooling heat medium circulating in the heat medium circuit flows, or the like in addition to a refrigerant passage through which the refrigerant circulating in the refrigerant circuit of the heat pump cycle device flows.

The compressor 20 is within an outline of the flow passage box 12 formed of the rectangular flat plates. In a positional relationship between the flow passage box 12 and the compressor 20, a rotation axis O of a rotary shaft 22 in the compressor 20 extends in parallel to a main surface of the flow passage box 12, which has the largest area of surfaces of the flow passage box 12 formed of the rectangular flat plates. Here, the rotary shaft 22 will be described later. More specifically, the rotation axis O of the rotary shaft 22 extends in parallel to a longitudinal direction of the main surface of the flow passage box 12. Note that the compressor 20 may be disposed such that the rotation axis O of the rotary shaft 22 extends perpendicular to the main surface of the flow passage box 12.

The compressor 20 includes the rotary shaft 22, a compression part 24, a motor 26, an inverter 28, and a housing 30.

The housing 30 includes a compression part housing 32, a motor housing 34, an inverter housing 36, and a shaft support member 37. The compression part housing 32 and the motor housing 34 each have a substantially cylindrical shape. More specifically, the compression part housing 32 is formed in a bottomed cylindrical shape and has a peripheral wall formed in a cylindrical shape extending in an axial direction of the rotary shaft 22 and a bottom wall connected to a front end of this peripheral wall. The compression part housing 32 is opened at a rear end thereof. In addition, the motor housing 34 is formed in a bottomed cylindrical shape and has a peripheral wall formed in a cylindrical shape extending in the axial direction of the rotary shaft 22 and a bottom wall 34B connected to a rear end of this peripheral wall. The motor housing 34 is opened at a front end thereof. The inverter housing 36 is formed in a substantially rectangular flat shape. The shaft support member 37 is formed in a substantially circular flat shape.

The rotary shaft 22 is disposed inside the compression part housing 32 and the motor housing 34. The rotary shaft 22 is formed in a columnar shape extending in the front-rear direction of the compressor 20. The rotary shaft 22 is rotatably supported around the rotation axis O by the motor housing 34 and the shaft support member 37.

The compression part housing 32 and the motor housing 34 are arranged in a direction in which the rotation axis O of the rotary shaft 22 extends. The motor housing 34 is located behind the compression part housing 32. That is, the compression part housing 32 is disposed opposite to the bottom wall 34B of the motor housing 34 across the motor 26.

The motor housing 34 and the inverter housing 36 are arranged in a radial direction of the rotary shaft 22. That is, the inverter housing 36 is provided on a side surface of the motor housing 34, that is, on an outer peripheral surface side of the motor housing 34.

In the following description, the direction in which the rotation axis O extends is simply called the axial direction. That is, the axial direction means the axial direction of the rotary shaft 22, and a view in the axial direction means the view in the axial direction of the rotary shaft 22. In addition, the radial direction means the radial direction of the rotary shaft 22, that is, a direction orthogonal to the axial direction of the rotary shaft 22. This direction orthogonal to the axial direction of the rotary shaft 22 includes a width direction of and a height direction of the inverter housing 36 (an extending portion 36B, which will be described later) as viewed in axial direction. Furthermore, the axial direction coincides with the front-rear direction of the compressor 20, and for the convenience of explanation, one side in the axial direction means a front side of the compressor 20 and the other side in the axial direction means a rear side of the compressor 20. The width direction of the inverter housing 36 coincides with the left-right direction of the compressor 20, and the height direction of the inverter housing 36 coincides with the up-down direction of the compressor 20.

The compression part housing 32 cooperates with the shaft support member 37 to define a compression part chamber 32A. The motor housing 34 cooperates with the shaft support member 37 to define a motor chamber 34A. The motor chamber 34A is formed inside the peripheral wall of the motor housing 34. The inverter housing 36 cooperates with the motor housing 34 to define an inverter chamber 36A. The inverter chamber 36A is formed on the outer peripheral surface side of the peripheral wall of the motor housing 34. The shaft support member 37 is located between the opening of the compression part housing 32 and the opening of the motor housing 34. This shaft support member 37 cooperates with the compression part housing 32 to define the compression part chamber 32A and cooperates with the motor housing 34 to define the motor chamber 34A. The shaft support member 37 has an insertion hole 37A through which the rotary shaft 22 is inserted and rotatably supports the rotary shaft 22.

The compression part 24 is accommodated in the compression part chamber 32A. The compression part 24 compresses refrigerant by rotation of the rotary shaft 22. The refrigerant is an example of the “fluid” in the present disclosure. The compression part 24 is connected to the refrigerant passage of the flow passage box 12 through a high pressure refrigerant hose 14. The motor chamber 34A is connected to the refrigerant passage of the flow passage box 12 through a low pressure refrigerant hose, which is not illustrated. The refrigerant flowing from the refrigerant passage of the flow passage box 12 into the motor chamber 34A through the low pressure refrigerant hose is sucked into the compression part 24 through a suction passage formed in the shaft support member 37. Here, an illustration of the suction passage is omitted.

The compression part 24 includes a fixed scroll and an orbiting scroll, which are not illustrated. In the compression part 24, the orbiting scroll rotates by the rotation of the rotary shaft 22, which changes a volume of a compression chamber formed between the fixed scroll and the orbiting scroll. As a result, the compression part 24 sucks the refrigerant from the refrigerant passage of the flow passage box 12 through the low pressure refrigerant hose, compresses the refrigerant, and discharges the compressed refrigerant. The refrigerant discharged from the compression part 24 flows into the refrigerant passage of the flow passage box 12 through the high pressure refrigerant hose 14.

The motor 26 is accommodated in the motor chamber 34A. The motor 26 has a stator and a rotor, which are not illustrated. The stator is connected to the inverter 28. The rotary shaft 22 is fixed to the rotor. The rotor is rotated by a power supplied from the inverter 28 to the stator, which rotates the rotary shaft 22.

The inverter 28 is accommodated in the inverter chamber 36A. As illustrated in FIG. 4, the inverter 28 includes an inverter circuit 28A, a control circuit 28B, and a high voltage input filter 28C. The inverter circuit 28A drives the motor 26. The control circuit 28B controls the inverter circuit 28A. The high voltage input filter 28C reduces noise in a power supplied from an external power supply 57 through a power supply connector 56, which will be described later. The inverter circuit 28A, the control circuit 28B, and the high voltage input filter 28C are each formed of an empty circuit board and electronic devices, switching elements, or the like mounted on the empty circuit board.

The compressor 20 includes three conductive pins 42 and three jacks 52. Each of the jacks 52 is an example of an “inverter terminal” in the present disclosure. The three conductive pins 42 are arranged side by side in the left-right direction. The conductive pins 42 have the same configuration. The three jacks 52 are arranged side by side in the left-right direction. The jacks 52 have the same configuration.

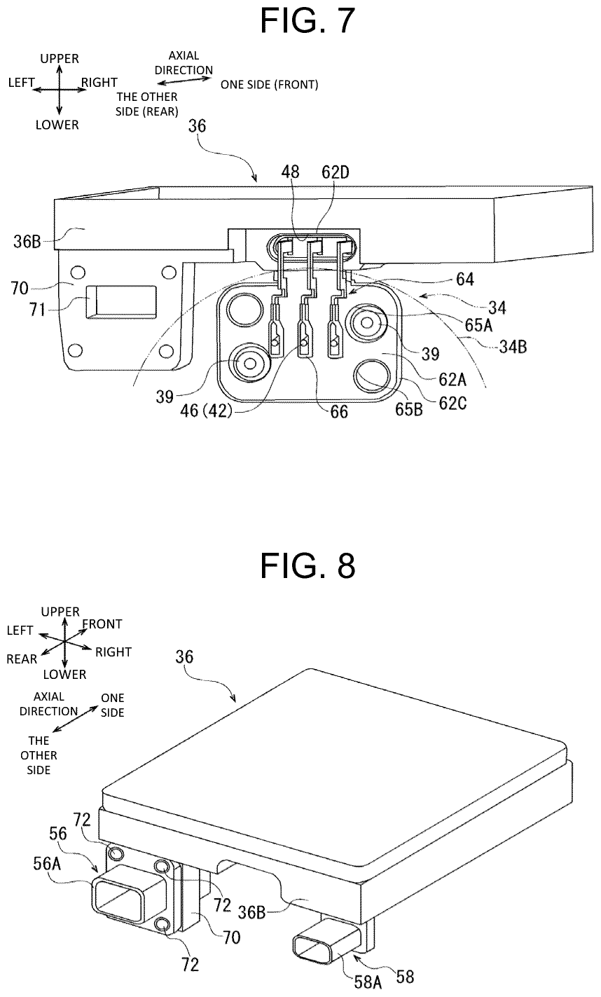

As illustrated in FIGS. 6 and 7, the conductive pins 42 are each formed in a stick shape and disposed in a hermetically sealed terminal 38. In the hermetically sealed terminal 38, an insulating member is interposed between any adjacent two of the conductive pins 42.

As illustrated in FIG. 6, the hermetically sealed terminal 38 is provided on the bottom wall 34B of the motor housing 34. The bottom wall 34B is located at an end of the motor housing 34 on the other side in the axial direction. The bottom wall 34B is formed in a substantially disc shape and extends in the radial direction at the end of the motor housing 34 on the other side in the axial direction. A first through hole 34C (see FIG. 1) is formed in the bottom wall 34B, and the first through hole 34C extends through the bottom wall 34B in the axial direction and connects the motor chamber 34A to the outside thereof. The hermetically sealed terminal 38 is disposed in this first through hole 34C. Each of the conductive pins 42 in the hermetically sealed terminal 38 extends straight in the axial direction through the bottom wall 34B. The hermetically sealed terminal 38 is fixed to the bottom wall 34B by two first fastening members 39. The hermetically sealed terminal 38 ensures air-tightness of the motor chamber 34A.

The conductive pins 42 are electrically connected to the motor 26. One end portion of each of the conductive pins 42 is inserted into a terminal box 44 that is made of resin and disposed in the motor chamber 34A (see FIG. 1). Although not illustrated, in the terminal box 44, three motor wires extending from the stator of the motor 26 through connecting terminals are each electrically connected to the one end portion of the corresponding conductive pin 42. The other end portion of each of the conductive pins 42 is a connection end portion 46 that protrudes from the bottom wall 34B to the outside of the motor chamber 34A in the axial direction.

As illustrated in FIG. 6, the inverter housing 36 has an extending portion through hole 48 in an end of the inverter housing 36 on the other side in the axial direction, that is, at an end of the extending portion 36B, which will be described later. The extending portion through hole 48 extends straight in the axial direction and is opened toward the other side in the axial direction at the end of the extending portion 36B. The extending portion through hole 48 allows the inverter chamber 36A to communicate with the outside. The extending portion through hole 48 is formed in an elongated hole shape whose longitudinal direction coincides with the left-right direction of the compressor 20.

As illustrated in FIGS. 1 and 4, the jacks 52 are disposed in the inverter chamber 36A of the inverter housing 36. The jacks 52 each face the extending portion through hole 48 in the axial direction. As illustrated in FIG. 12, the jacks 52 each have a pair of holding pieces that hold the corresponding plug 68 therebetween by an elastic restoring force. Here, plugs 68 will be described later. The jacks 52 each have an opening end into which the corresponding plug 68 is engaged at the end of the jack 52 on the other side in the axial direction. An opening at the opening end of each of the jacks 52 increases in diameter such that the corresponding plug 68, which moves relative to the jack 52, is easily inserted into the opening as the jack 52 extends toward the other side in the axial direction. Thus, when the plugs 68 are moved in the axial direction relative to the jacks 52 and engaged into the jacks 52, the plugs 68 and the jacks 52 are connected to each other.

The jacks 52 are electrically connected to the inverter circuit 28A through three conductive members 54 (see FIG. 4).

As illustrated in FIG. 6, the inverter housing 36 has the extending portion 36B extending in the axial direction relative to the bottom wall 34B of the motor housing 34 away from the peripheral wall of the motor housing 34. The extending portion 36B extends relative to bottom wall 34B toward the other side in the axial direction. As also illustrated in FIG. 4, a rear end portion of the inverter housing 36 corresponds to the extending portion 36B. In the left-right direction, a width of the extending portion 36B is equivalent to a width of a remaining portion of the inverter housing 36 excluding the extending portion 36B. The extending portion 36B protrudes in the axial direction relative to the bottom wall 34B of the motor housing 34 over an electric connecting member 60, which will be described later.

As illustrated in FIGS. 1 to 4, the power supply connector 56 and a communication connector 58 are connected to the extending portion 36B. The power supply connector 56 is an example of the “high voltage connector” in the present disclosure. The communication connector 58 is an example of the “low voltage connector” in the present disclosure. A power is supplied from the external power supply 57 to the motor 26 through the power supply connector 56. The external power supply 57 is an example of the “high voltage power supply” in the present disclosure. The communication connector 58 sends control signals from an external controller 59 to the control circuit 28B of the inverter 28. Here, the control signals have a power smaller than the power supplied from the external power supply 57. The external controller 59 is an example of the “low voltage power supply” in the present disclosure.

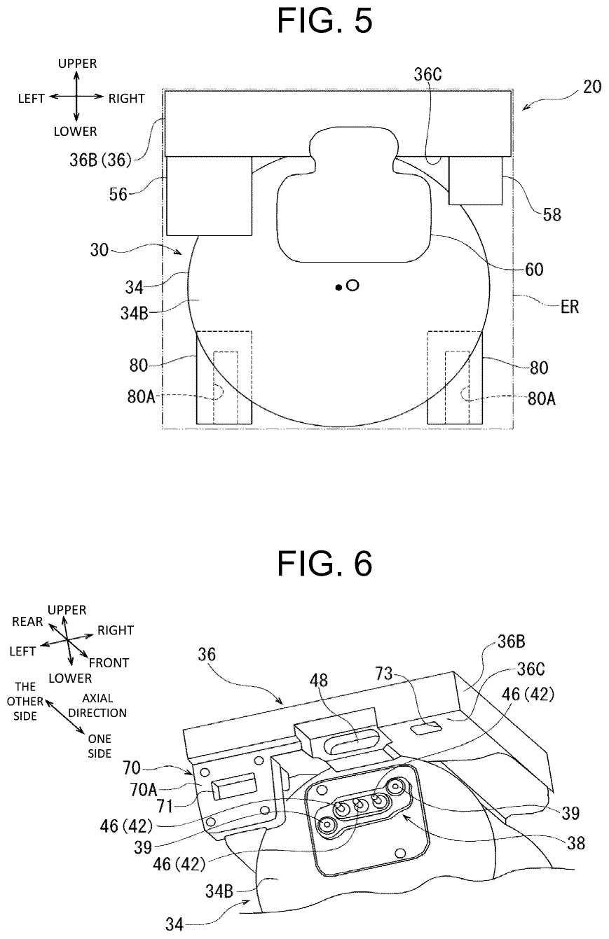

As illustrated in FIGS. 5 and 6, the power supply connector 56 and the communication connector 58 are connected to an outer bottom surface 36C of the extending portion 36B near the motor housing 34. As viewed in the axial direction, a portion of the power supply connector 56 is overlapped with the bottom wall 34B and a portion of the communication connector 58 is overlapped with the bottom wall 34B.

As also illustrated in FIG. 7, a mounting base 70 is formed integrally with the extending portion 36B and located on a left end portion of the outer bottom surface 36C of the extending portion 36B on the other side in the axial direction. The mounting base 70 has a first communication hole 71 formed in a substantially L-shape extending through the mounting base 70. One end of the first communication hole 71 is opened in the outer bottom surface 36C and the other end of the first communication hole 71 is opened in an end surface 70A of the mounting base 70 on the other side in the axial direction. The first communication hole 71 connects the inverter chamber 36A to the outside thereof.

As illustrated in FIG. 8, the power supply connector 56 is fixed to the end surface 70A of the mounting base 70 on the other side in the axial direction by four third fastening members 72. Note that in FIG. 8, three of the four third fastening members 72 are illustrated. The power supply connector 56 has a power supply connector connecting portion 56A.

As illustrated in FIGS. 1, 2, and 4, a rear end portion of the power supply connector connecting portion 56A in the power supply connector 56 slightly protrudes over the extending portion 36B in the axial direction.

One end of a power supply cable 57A is connected to the external power supply 57. The power supply cable 57A is an example of the “high voltage cable” of the present disclosure. A power supply cable connector 57B is provided at the other end of the power supply cable 57A. The power supply cable connector 57B is an example of the “high voltage cable connector” in the present disclosure. This power cable connector 57B is connected to the power supply connector connecting portion 56A of the power supply connector 56 in the axial direction.

As illustrated in FIG. 6, a second communication hole 73 is formed in a right end portion of the outer bottom surface 36C of the extending portion 36B on the other side in the axial direction. The second communication hole 73 connects the inverter chamber 36A to the outside thereof.

As illustrated in FIG. 8, the communication connector 58 is fixed to a portion of the outer bottom surface 36C around this second communication hole 73 by fastening members, which are not illustrated. The communication connector 58 has a communication connector connecting portion 58A.

As illustrated in FIGS. 2 and 4, a rear end portion of the communication connector connecting portion 58A in the communication connector 58 slightly protrudes over the extending portion 36B in the axial direction.

One end of a communication cable 59A is connected to the external controller 59. The communication cable 59A is an example of the “low voltage cable” of the present disclosure. A communication cable connector 59B is provided at the other end of the communication cable 59A. The communication cable connector 59B is an example of the “low voltage cable connector” in the present disclosure. This communication cable connector 59B is connected to the communication connector connecting portion 58A of the communication connector 58 in the axial direction.

The power supply connector connecting portion 56A of the power supply connector 56 is electrically connected to the inverter circuit 28A of the inverter 28 through a power supply side conductive member, which is not illustrated. The communication connector connecting portion 58A of the communication connector 58 is electrically connected to the control circuit 28B of the inverter 28 through a communication side conductive member, which is not illustrated.

As illustrated in FIG. 5, the power supply connector 56 and the communication connector 58 are disposed within the width of the extending portion 36B as viewed in the axial direction. Note that a circumscribed rectangular ER in which the inverter housing 36 including the extending portion 36B and the motor housing 34 are present is, as viewed in the axial direction, illustrated by a long dashed double short dashed line in FIG. 5. As viewed in the axial direction, the power supply connector 56, the communication connector 58, and the electric connecting member 60 located between these connectors are disposed within the circumscribed rectangular ER.

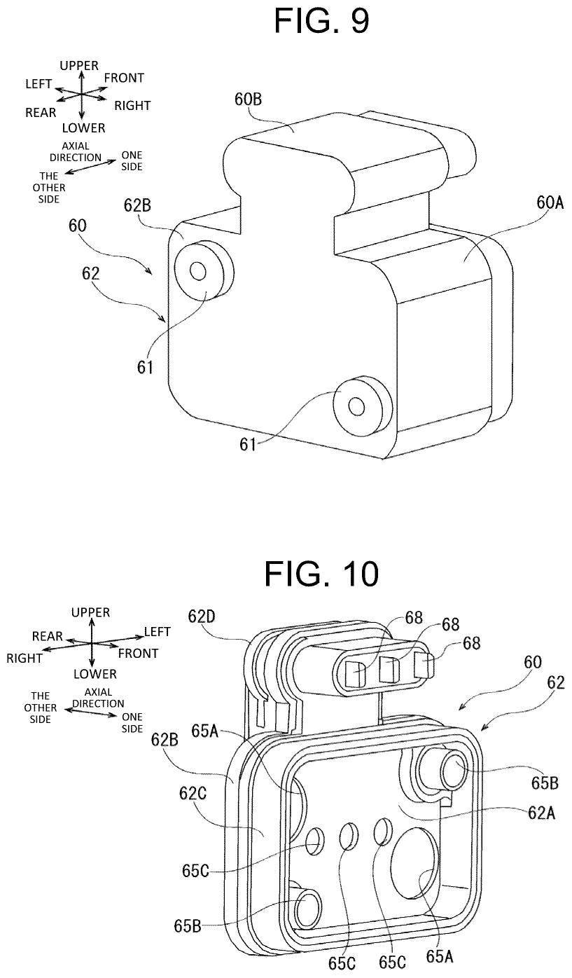

The electric connecting member 60 is provided outside the housing 30 on the other side in the axial direction. The electric connecting member 60 is located between the bottom wall 34B of the motor housing 34 and the end of the extending portion 36B in the axial direction. The electric connecting member 60 is fixed to the bottom wall 34B by two second fastening members 61 (see FIG. 9) with a head 60B of the electric connecting member 60 extending through the extending portion through hole 48. Here, the head 60B of the electric connecting member 60 will be described later. The electric connecting member 60 electrically connects the conductive pins 42 to the jacks 52. In attachment of this electric connecting member 60, when the electric connecting member 60 is moved in the axial direction, receptacle terminals 66 are connected to the connection end portions 46 of the conductive pins 42 and the plugs 68 are connected to the jacks 52 by engagement. The receptacle terminals 66 and the plugs 68 will be described later.

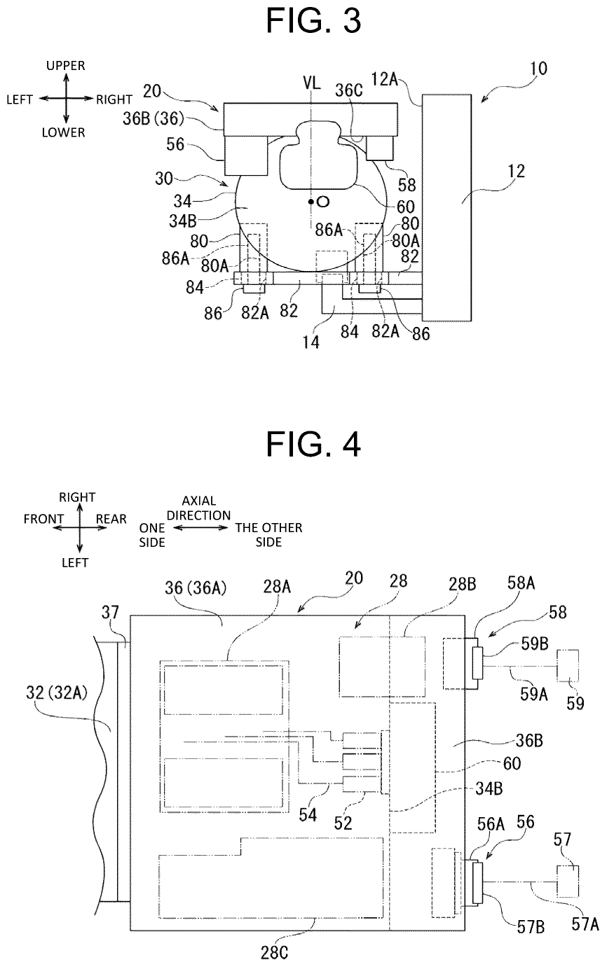

As illustrated in FIG. 3, the electric connecting member 60 is disposed on an imaginary straight line VL. The imaginary straight line VL intersects with the rotation axis O of the rotary shaft 22 and extends in the up-down direction orthogonal to the axial direction. Furthermore, as also illustrated in FIG. 5, in the left-right direction orthogonal to the axial direction, the electric connecting member 60 is interposed between the power supply connector 56 and the communication connector 58. That is, the power supply connector 56 is disposed opposite to the communication connector 58 across the electric connecting member 60.

As illustrated in FIG. 9, the electric connecting member 60 has a body 60A and the head 60B. The body 60A is formed in a substantially rectangular shape when viewed in a cross-section orthogonal to the axial direction (the front-rear direction). The head 60B is formed in a substantially elongated circular shape having a pair of straight portions extending in parallel to each other in the left-right direction, which are longitudinal sides of the head 60B, when viewed in the cross-section orthogonal to the axial direction.

As also illustrated in FIGS. 10 to 12, the electric connecting member 60 has a case 62, three busbars 64, the three receptacle terminals 66, and the three plugs 68. Each of the receptacle terminals 66 is an example of the “first terminal” of the present disclosure. Each of the plugs 68 is an example of the “second terminal” in the present disclosure.

The plugs 68 are formed integrally with the busbars 64 and located at one end portions of the busbars 64 on the one side in the axial direction. The plugs 68 extend straight in the axial direction.

As illustrated in FIG. 10, the plugs 68 are disposed outside the case 62. The plugs 68 are inserted into the inverter chamber 36A through the extending portion through hole 48. As illustrated in FIGS. 1 and 12, the plugs 68 are connected to the jacks 52 which are disposed in the inverter chamber 36A.

The receptacle terminals 66 are fixed to the other end portions of the busbars 64. The receptacle terminals 66 are each fixed at a predetermined position inside the case 62. That is, as the case 62 is moved in a surface direction of the bottom wall 34B of the motor housing 34, the receptacle terminals 66 are also moved in the surface direction of the bottom wall 34B of the motor housing 34. A diameter of an opening of each of the receptacle terminals 66 into which the connecting end portion 46 of the corresponding conductive pin 42 is inserted is the same as a diameter of the connecting end portion 46 of the conductive pin 42.

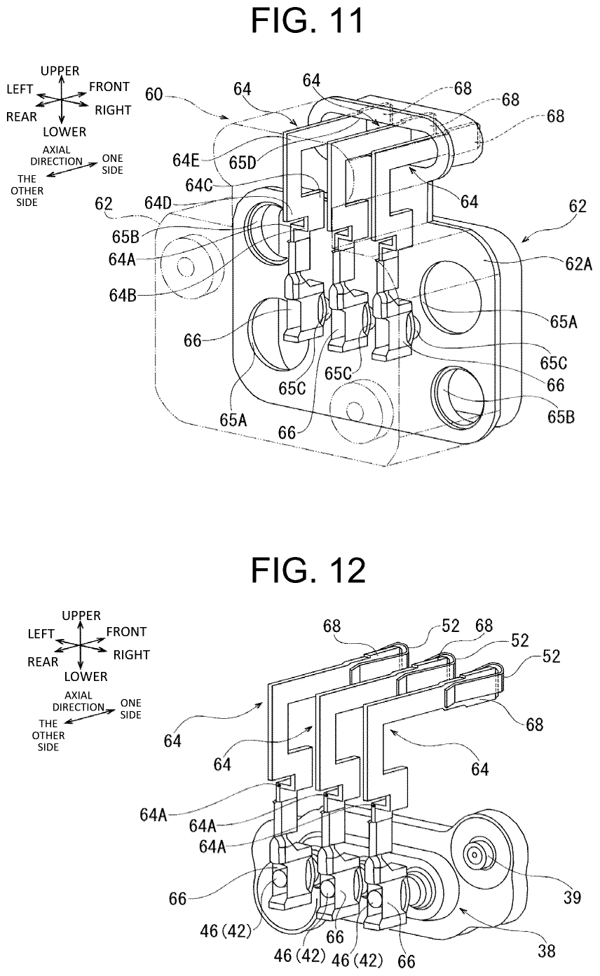

As illustrated in FIG. 11, the busbars 64 are disposed such that a thickness direction of each of the busbars 64 coincides with the direction orthogonal to the axial direction. Each of the busbars 64 is formed in a belt-like plate shape and formed as one piece by bending a metal plate or other processing. Each of the busbars 64 has three edge-wise bending portions and two flat-wise bending portions. More specifically, each of the busbars 64 has a first flat-wise bending portion 64A, a second flat-wise bending portion 64B, a first edge-wise bending portion 64C, a second edge-wise bending portion 64D, and a third edge-wise bending portion 64E, which are arranged in this order from the other end portion to the one end portion.

Thus, the busbars 64 are bent by edge-wise bending so that the plugs 68 are engaged with the jacks 52, and the busbars 64 are also bent by flat-wise bending so that positions of the receptacle terminals 66 are adjustable in the surface direction of the bottom wall 34B of the motor housing 34.

That is, in each of the busbars 64, the corresponding receptacle terminal 66, which is formed in the other end portion of the busbar 64, is swingable with the first flat-wise bending portion 64A as a fulcrum relative to a position of the plug 68, which is formed in the one end portion of the busbars 64, in the direction orthogonal to the axial direction, that is, in the surface direction of the bottom wall 34B of the motor housing 34. The busbars 64 are accommodated in the case 62. Accordingly, the electric connecting member 60 has a configuration in which as the case 62 is moved in the surface direction of the bottom wall 34B of the motor housing 34, each of the receptacle terminals 66, which is provided on the other end portion of the corresponding busbar 64 accommodated in the case 62, is swingable in the surface direction of the bottom wall 34B of the motor housing 34. As a result, in each of the busbars 64, the receptacle terminal 66 is engaged with the conductive pin 42 while the plug 68 is engaged into the jack 52. Thus, the receptacle terminals 66 are connected to the conductive pins 42 outside the motor housing 34.

As illustrated in FIG. 10, the case 62 has a base portion 62A made of resin, a cover portion 62B made of resin, a first seal portion 62C, and a second seal portion 62D.

The base portion 62A and the cover portion 62B each have a body-corresponding portion having a shape in correspondence with the body 60A of the electric connecting member 60 as viewed in the cross-section orthogonal to the axial direction and a head-corresponding portion having a shape in correspondence with the head 60B of the electric connecting member 60 as viewed in the cross-section orthogonal to the axial direction.

As illustrated in FIGS. 10 and 11, the base portion 62A has two first insertion holes 65A, two second insertion holes 65B, three second through holes 65C, and one third insertion hole 65D. The first insertion holes 65A, the second insertion holes 65B, and the second through holes 65C are formed in the body-corresponding portion of the base portion 62A. The third insertion hole 65D is formed in the head-corresponding portion of the base portion 62A.

The body-corresponding portion of the base portion 62A is disposed so as to surround the hermetically sealed terminal 38, which is provided on the bottom wall 34B. That is, the hermetically sealed terminal 38 is accommodated in the case 62, and not exposed to an outside of the case 62.

The first fastening members 39 used for fixing the hermetically sealed terminal 38 to the bottom wall 34B are inserted into the first insertion holes 65A.

The second fastening members 61 used for fixing the electric connecting member 60 to the bottom wall 34B are inserted into the second insertion holes 65B. The connection ends 46 of the conductive pins 42 pass through the second through holes 65C. Portions of the three bus bars 64 near the plugs 68 and a part of the case 62 are inserted into the third insertion hole 65D.

The cover portion 62B is integrated with the base portion 62A with the busbars 64 and the receptacle terminals 66 interposed between the cover portion 62B and the base portion 62A. That is, the busbars 64 and the receptacle terminals 66 are accommodated in the case 62. The cover portion 62B provides insulation among the busbars 64.

The first seal portion 62C is formed of a ring-shaped packing that surrounds the body-corresponding portion of the base portion 62A. As illustrated in FIG. 7, in a state where the electric connecting member 60 is attached to the bottom wall 34B, an end surface of the first seal portion 62C having the ring shape comes in contact with the bottom wall 34B, which forms a flat surface sealing portion.

The second seal portion 62D is disposed at the head-corresponding portion of the cover portion 62B. The second seal portion 62D is formed of a ring-shaped packing whose outer peripheral surface has a shape in correspondence with a shape of an inner peripheral surface of the extending portion through hole 48 of the inverter housing 36. As illustrated in FIG. 7, in the state where the electric connecting member 60 is attached to the bottom wall 34B, the outer peripheral surface of the second seal portion 62D having the ring shape comes in contact with the inner peripheral surface of the extending portion through hole 48, which forms a cylindrical (tubular) sealing portion.

As illustrated in FIGS. 1 to 3, three mounting legs 80 are provided on the housing 30. The mounting legs 80 are each formed integrally with an outer surface of the housing 30, that is, an outer peripheral surface of the peripheral wall of the motor housing 34 or an outer peripheral surface of the peripheral surface of the compression part housing 32.

Two of the three mounting legs 80 are formed on the motor housing 34 and the remaining one is formed on the compression part housing 32. More specifically, the two mounting legs 80 are each disposed in lower portions in rear left and rear right end portions of the motor housing 34. In addition, the remaining mounting leg 80 is disposed in a lower portion of in a rear right end portion of the compression part housing 32.

As illustrated in FIG. 5, as viewed in the axial direction, the three mounting legs 80 are disposed within the circumscribed rectangular ER of the housing 30 in which the inverter housing 36 and the motor housing 34 are present. In addition, as viewed in the axial direction, the three mounting legs 80 are located opposite to the inverter housing 36 across the power supply connector 56 and the communication connector 58. More specifically, as viewed in the axial direction, the mounting leg 80 disposed on the lower portion of in the rear left end portion of the motor housing 34 is located opposite to the inverter housing 36 across the power supply connector 56. This mounting leg 80 and the power supply connector 56 are away from each other by a predetermined distance in the up-down direction. In addition, as viewed in the axial direction, the mounting leg 80 disposed in the lower portion of the rear right end portion of the motor housing 34 and the mounting leg 80 disposed in the lower portion in the rear right end portion of the compression part housing 32 are located opposite to the inverter housing 36 across the communication connector 58. This mounting leg 80 disposed on the lower portion of the rear right end portion of the motor housing 34 and the communication connector 58 are away from each other by a predetermined distance in the up-down direction.

The mounting legs 80 extend in parallel to each other in the up-down direction. In other words, the mounting legs 80 extend in a direction orthogonal to or substantially orthogonal to the circuit board on which the inverter circuit 28A in the inverter chamber 36A is mounted. The mounting legs 80 extend in the up-down direction and each have an internal thread hole 80A that is opened downward.

As illustrated in FIGS. 1 to 3, three mounting portions 82 each formed in a plate shape are provided on the flow passage box 12. Each of the mounting portions 82 is an example of the “object” to which the motor housing 34 is mounted in the present disclosure. The mounting portions 82 extend from a left side surface 12A of the flow passage box 12 horizontally in the left direction. The mounting portions 82 each have a mounting hole 82A at a position corresponding to the mounting leg 80.

A damper 84 is provided in each of the mounting holes 82A. Although not illustrated, the damper 84 has an outer cylinder, an inner cylinder, and a tubular rubber elastic body that connects the outer cylinder to the inner cylinder. The outer cylinder of the damper 84 is engaged with the corresponding mounting hole 82A. An external thread portion 86A of a fourth fastening member 86 for fastening the mounting leg 80 to the mounting portion 82 is inserted into the inner cylinder of the damper 84. Then, the external thread portion 86A of the fourth fastening member 86 is screwed into the internal thread hole 80A of the mounting leg 80. Thus, the compressor 20 is fixed to the flow passage box 12 by three-point support of the three mounting legs 80.

In this compressor 20, the power supply connector 56 and the communication connector 58 are connected to the outer bottom surface 36C being a lower surface of the extending portion 36B of the inverter housing 36, which extends in the axial direction relative to the bottom wall 34B of the motor housing 34. Then, as viewed in the axial direction, the power supply connector 56 and the communication connector 58 are disposed such that the power supply connector 56 and the communication connector 58 are overlapped with the bottom wall 34B.

Therefore, as compared with a case where these connectors are provided so as to protrude from an upper surface of the extending portion 36B, it is suppressed that the inverter housing 36 increases in size in the radial direction and the up-down direction, which are orthogonal to the axial direction. In addition, it is suppressed that the power supply connector 56 and the communication connector 58 are damaged in the axial direction by an external impact due to the bottom wall 34B.

Furthermore, as viewed in the axial direction, the power supply connector 56 and the communication connector 58 are disposed within the width of the extending portion 36B. This suppresses an increase of size of the inverter housing 36 in the width direction orthogonal to the axial direction by the power supply connector 56 and the communication connector 58. This also suppresses that the power supply connector 56 and the communication connector 58 are damaged in the width direction of the inverter housing 36 by an external impact.

Accordingly, in the compressor 20 in which the inverter housing 36 is provided on the peripheral wall of the motor housing 34, it is suppressed that the inverter housing 36 increases in size in the direction orthogonal to the axial direction and that the power supply connector 56 and the communication connector 58 are damaged.

In this compressor 20, as viewed in the axial direction, the electric connecting member 60 that electrically connects the conductive pins 42 to the jacks 52 is disposed between the power supply connector 56 and the communication connector 58. With this configuration, a distance between the power supply connector 56 and the communication connector 58 is easily ensured, which is advantageous for reducing noise transmitting from the power supply connector 56 to the communication connector 58. In addition, since the electric connecting member 60 does not protrude over the extending portion 36B in the width direction thereof, the compressor 20 does not also increase in size in the width direction of the inverter housing 36 by the electric connecting member 60. It is also suppressed that the electric connecting member 60 is damaged in the axial direction and in the width direction of the inverter housing 36 by an external impact.

In this compressor 20, the conductive pins 42 and the receptacle terminals 66 in the electric connecting member 60 are connected to each other and the plugs 68 and the jacks 52 in the inverter housing 36 are connected to each other by moving the electric connecting member 60 in the axial direction. In addition, the power supply connector 56 and the power supply cable 57A are connected to each other in the axial direction and the communication connector 58 and the communication cable 59A are connected to each other in the axial direction. As a result, these connections become easy and also a working space for these connections is easily ensured. This makes an assembly of the compressor 20 simple.

In this compressor 20, the mounting legs 80 for mounting the housing 30 to the mounting portions 82 are separated from the inverter housing 36 by the power supply connector 56 and the communication connector 58. That is, the mounting leg 80 disposed at the lower portion of the rear left end portion of the motor housing 34 is separated from the inverter housing 36 by the power supply connector 56. In addition, the mounting leg 80 provided at the lower portion of the rear right end portion of the motor housing 34 is separated from the inverter housing 36 by the communication connector 58. With this configuration, even when the mounting legs 80 are damaged by an external impact, this damage of the mounting legs 80 hardly affects the inverter housing 36. As a result, it is suppressed that the inverter circuit 28A or the like is affected by the damage of the mounting legs 80 to be damaged.

In this compressor 20, the three mounting legs 80 formed on the housing 30, the power supply connector 56, the communication connector 58, and the electric connecting member 60 are disposed within the circumscribed rectangular ER of the housing 30 as viewed in the axial direction, and these members do not protrude over the circumscribed rectangular ER. Accordingly, it is suppressed that the compressor 20 increases in size in the width direction of the inverter housing 36 and the height direction, which are orthogonal to the axial direction, by protruding portions of the mounting legs 80 and the other members over the circumscribed rectangular ER. In addition, it is suppressed that the mounting legs 80 and the other members are damaged in the axial direction and the width direction of the inverter housing 36 by an external impact.

In this compressor 20, the air-tightness of the case 62 surrounding the hermetically sealed terminal 38 is ensured by the flat surface sealing portion formed of the first seal portion 62C provided in the electric connecting member 60, and the air-tightness around the extending portion through hole 48 of the inverter housing 36 is ensured by the cylindrical sealing portion formed of the second seal portion 62D provided in the electric connecting member 60. Accordingly, air-tightness of the inverter chamber 36A and the motor chamber 34A is easily ensured by the electric connecting member 60.

In this compressor 20, the inverter housing 36 is disposed on the outer peripheral surface side of the motor housing 34, and the motor housing 34 and the inverter housing 36 are arranged in the radial direction. This suppresses that an axial length of the compressor 20 increases.

In this compressor 20, the portion of the power supply connector 56 and the portion of the communication connector 58 are overlapped with the extending portion 36B in the axial direction. Therefore, a length of the protruding portion in the axial direction over the extending portion 36B in each of the power supply connector 56 and the communication connector 58 is shortened by the length of an overlapping portion with the extending portion 36B in each of the power supply connector 56 and the communication connector 58.

### Second Embodiment

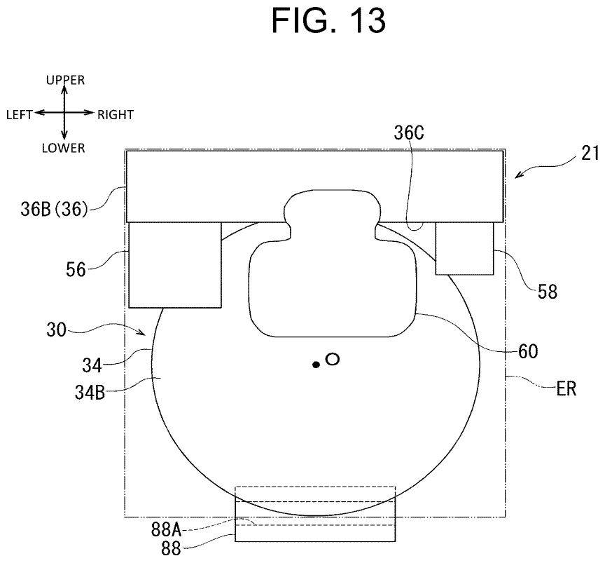

As illustrated in FIG. 13, in a compressor 21 of the second embodiment, three mounting legs 88 or the like are formed on the outer surface of the housing 30. In detail, one mounting leg 88 is formed integrally with the outer peripheral surface of the peripheral wall of the motor housing 34 and two mounting legs 88, which are not illustrated, are formed integrally with an outer peripheral surface of a peripheral wall of a compression part housing.

The mounting leg 88 formed on the motor housing 34 is disposed in a lower end portion in a rear end portion of the motor housing 34. The two mounting legs formed on the compression part housing are respectively disposed in an upper end portion and a lower end portion in a rear end portion of the compression part housing.

These mounting legs 88 or the like extend in parallel to each other in the left-right direction. In other words, the mounting legs 88 or the like extend in parallel to or substantially in parallel to the circuit board on which the inverter circuit 28A is mounted. The mounting leg 88 formed on the motor housing 34 extends in the left-right direction and has a thread insertion hole 88A that is opened at both ends thereof. The two mounting legs 88 formed on the compression part housing each have a thread insertion hole, which is not illustrated, similar to the thread insertion hole 88A.

Although not illustrated, each of the mounting legs 88 or the like is fixed to a corresponding mounting portion extending from the flow passage box 12 by a fastening member that is inserted through the thread insertion hole 88A or the like.

As viewed in the axial direction, a lower half portion of the mounting leg 88 disposed in the lower end portion of the motor housing 34 of these mounting legs 88 or the like and a lower half portion of the mounting leg 88 disposed in the lower end portion of the compression part housing of these mounting legs 88 or the like protrude downward over the circumscribed rectangular ER of the housing 30. On the other hand, an upper half portion of the mounting leg 88 disposed in the lower end portion of the motor housing 34, an upper half portion of the mounting leg 88 disposed in the lower end portion of the compression part housing, and the mounting leg 88 disposed in the upper end portion of the compression part housing are disposed within the circumscribed rectangular ER of the housing 30.

With this configuration, this compressor 21 is slightly larger in the up-down direction by a length of the lower half portion protruding over the circumscribed rectangular ER in the mounting legs 88 or the like disposed in the lower end portion of the housing 30 as compared with the compressor 20 of the first embodiment.

In addition, the mounting leg 88 disposed in the lower end portion of the motor housing 34 is separated from the inverter housing 36 by the electric connecting member 60. With this configuration, even when the mounting leg 88 is damaged, this damage of the mounting leg 88 hardly affects the inverter housing 36. As a result, it is suppressed that the inverter circuit 28A or the like is affected by the damage of the mounting leg 88 to be damaged.

Other configurations and advantageous effects in the second embodiment are the same as those in the first embodiment.

Although the present disclosure has been described above based on the first and second embodiments, the present disclosure is not limited to the above-described first and second embodiments, and may be modified within the scope of the present disclosure.

For example, in the compressor 20 of the first embodiment, the rear end portion of the inverter housing 36 corresponds to the extending portion 36B and the width of the extending portion 36B in the left-right direction of the compressor 20 is equivalent to the width of the remained portion of the inverter housing 36 excluding the extending portion 36B; however, the present disclosure is not limited thereto, and a shape and a size of the extending portion 36B may be set as desired.

In the compressor 20 of the first embodiment, the rear end portion of the power supply connector 56 and the rear end portion of the communication connector 58 slightly protrude in the axial direction over the extending portion 36B; however, the present disclosure is not limited thereto. For example, the compressor 20 of the first embodiment may have a configuration in which the high voltage connector does not protrude in the axial direction over the extending portion 36B because the entire high voltage connector is overlapped with the extending portion 36B in the axial direction or a configuration in which the lower voltage connector does not protrude in the axial direction over the extending portion 36B because the entire low voltage connector is overlapped with the extending portion 36B in the axial direction.

In the compressor 20 of the first embodiment, as viewed in the axial direction, the power supply connector 56 and the communication connector 58 are arranged in the width direction of the extending portion 36B (the left-right direction of the compressor 20); however, the present disclosure is not limited thereto. For example, as viewed in the axial direction, the high voltage connector and the low voltage connector may be arranged in the up-down direction of the compressor 20 (the direction orthogonal to or substantially orthogonal to the circuit board) within the width of the extending portion 36B.

In the compressor 20 of the first embodiment, the power supply cable 57A is connected to the power supply connector 56 in the axial direction and the communication cable 59A is connected to the communication connector 58 in the axial direction; however, the present disclosure is not limited thereto. For example, the high voltage cable may be moved in an upper direction of the compressor 20 (the direction orthogonal to or substantially orthogonal to the circuit board) and connected to the high voltage connector, and the low voltage cable may be moved in the upper direction of the compressor 20 (the direction orthogonal to or substantially orthogonal to the circuit board) and connected to the low voltage connector.

In the compressor 20 of the first embodiment, the power supply connector 56 and the communication connector 58 are provided on the outer bottom surface 36C of the extending portion 36B; however, the present disclosure in not limited thereto. For example, the high voltage connector or the low voltage connector may be provided on an end surface on the other side in the axial direction (a rear end surface) in the extending portion 36B (inverter housing 36).

In the compressor 20 of the first embodiment, the diameter of the opening of each of the receptacle terminals 66 into which the connection end portion 46 of the corresponding conductive pin 42 is inserted is the same as the diameter of the connecting end portion 46 of the conductive pin 42; however, the present disclosure is not limited thereto. For example, the diameter of the opening of the receptacle terminal 66 may be larger than the diameter of the connecting end portion 46 of the conductive pin 42. In this case, the position of each of the receptacle terminals 66 relative to the corresponding conductive pin 42 is further easily adjusted, which further improves the ease of the assembling of the electric compressor.

In the compressor 20 of the first embodiment, the base portion 62A and the cover portion 62B of the case 62 are made of resin; however, the present disclosure is not limited thereto. For example, the cover portion 62B may be made of metal in order to block electromagnetic noise, or the like.

### INDUSTRIAL APPLICABILITY

The present disclosure is applicable to an air conditioner for vehicles or the like.

What is claimed is:

1. An electric compressor comprising:
a rotary shaft;
a compression part that is driven by rotation of the rotary shaft to compress fluid;
a motor that rotates the rotary shaft;
an inverter that has an inverter circuit configured to drive the motor; and
a housing in which the rotary shaft, the compression part, the motor, and the inverter are accommodated,
the housing including:
a motor housing that is formed in a bottomed tubular shape having a tubular peripheral wall extending in an axial direction of the rotary shaft and a bottom wall connected to an end of the peripheral wall and in which the motor is accommodated inside the peripheral wall;
an inverter housing that is provided on the peripheral wall and in which the inverter is accommodated;
a compression part housing that is formed in a bottomed tubular shape and provided opposite to the bottom wall across the motor and in which the compression part is accommodated; and
a shaft support member that has an insertion hole through which the rotary shaft is inserted, the shaft support member being disposed between an opening of the motor housing and an opening of the compression part housing, the shaft support member rotatably supporting the rotary shaft, the shaft support member defining with the motor housing a motor chamber in which the motor is accommodated and defining with the compression part housing a compression part chamber in which the compression part is accommodated,
the inverter housing having an extending portion extending in the axial direction relative to the bottom wall away from the peripheral wall, and
the extending portion having:
a high voltage connector through which a power from a high voltage power supply is supplied to the motor; and
a low voltage connector through which a power smaller than the power supplied from the high voltage power supply is supplied to the inverter, wherein
the high voltage connector and the low voltage connector are each overlapped with the bottom wall as viewed in the axial direction of the rotary shaft, and
the high voltage connector and the low voltage connector are disposed within a width of the extending portion.

2. The electric compressor according to claim 1, wherein
a conductive pin is provided in the motor housing, the conductive pin extending through the bottom wall and being electrically connected to the motor,
the inverter housing has an extending portion through hole that is opened at the extending portion and in which an inverter terminal electrically connected to the inverter circuit is accommodated,
an electric connecting member is provided between the bottom wall and an end of the extending portion in the axial direction and electrically connects the conductive pin to the inverter housing, the electric connecting member extending through the extending portion through hole, and
the high voltage connector is disposed opposite to the low voltage connector across the electric connecting member as viewed in the axial direction.

3. The electric compressor according to claim 2, wherein
the electric connecting member has a busbar formed in a plate shape, a first terminal that is provided on one end portion of the busbar and to which the conductive pin is connected outside the motor housing, and a second terminal that is provided on the other end portion of the busbar and to which the inverter terminal is connected inside the inverter housing,
the first terminal is connected to the conductive pin in the axial direction,
the second terminal is connected to the inverter terminal in the axial direction,
a high voltage cable connector provided at one end of a high voltage cable through which the power from the high voltage power supply is supplied is connected to the high voltage connector in the axial direction, and
a low voltage cable connector provided at one end of a low voltage cable through which the power from the low voltage power supply is supplied is connected to the low voltage connector in the axial direction.

4. The electric compressor according to claim 1, wherein
a pair of mounting legs for mounting the motor housing to an object is formed on the peripheral wall, and
as viewed in the axial direction, one of the mounting legs is located opposite to the inverter housing across the high voltage connector and the other of the mounting legs is located opposite to the inverter housing across the low voltage connector.
